(19) United States
(12) Patent Application Publication
(10) Pub. No.: US 2010/0076846 A1
(43) Pub. Date: Mar. 25, 2010

(54) INTEREST MANAGER

(75) Inventors: Wendy M. Pfeiffer, San Jose, CA (US); Fanyee Lee, Palo Alto, CA (US); Lisa Galindo, San Francisco, CA (US); Michael W. Bevans, San Francisco, CA (US); Gayle Curtis, Palo Alto, CA (US); Catherine Needham, Oakland, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/237,982

(22) Filed: Sep. 25, 2008

(51) Int. Cl. G06Q 30/00

(52) U.S. Cl. 705/14.53

(57) ABSTRACT

Embodiments of methods, apparatuses, or systems associated with computer based target advertising based upon information collected about a user are disclosed.

### BACKGROUND

1. Field

The subject matter disclosed herein relates to computer based target advertising based upon information collected about a user.

2. Information

Advertising in an Internet environment may involve target or personalized advertising based upon user information. User information may include information that a user declares, such as information that a user voluntarily provides to a website and/or webpage by vehicles such as filling out a form or entering information unto a webpage. User information may include user behavior or actions, such as information related to which website and/or web pages a user visits, how long a user stays on a particular website or web page, or click-stream information. User information may include information inferred about a user based upon advertising models in conjunction with user declared information and/or user behavior information. Sometimes “cookies” or other tracking mechanisms are used to collect user information. Based upon this user information, personalized advertising may be selected for presentation to a user.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a flow chart depicting a method in accordance with an embodiment.

FIG. 2 is a screen shot of an example user interface for an interest manager, in accordance with an embodiment;

FIG. 3 is a screen shot depicting a user interface showing ad matching preferences, in accordance with an embodiment;

FIG. 4 is a screen shot depicting a user interface showing content preferences, in accordance with an embodiment;

FIG. 5 is a screen shot depicting a user interface showing account information, in accordance with an embodiment;

FIG. 6 is a diagram of an architecture for an interest manager, in accordance with an embodiment.

FIG. 7 is a diagram of a system for target advertising, in accordance with an embodiment; and

FIG. 8 is a diagram of a computing platform, in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and,” “and/or,” and “or” as used herein may include a variety of meanings that will depend at least in part upon the context in which it is used. Typically, “or” as well as “and/or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

In accordance with various embodiments, methods, articles and apparatuses may be provided which allow for interactive modification of information collected about a user, which may be used for target or personalized online advertising. Information collected associated with a user may be provided to the user. The user may interact with the collected information, by, for example, editing such collected information, providing feedback about such collected information, and/or indicating preferences and/or information accuracy. It should be understood, however, that these are merely examples of how a user may interactively modify collected information and claimed subject matter is not limited in this respect. Based upon such modified user information, advertising content may be generated and/or selected for presentation to the user.

Unlike “cookies,” or other tracking mechanisms, with one or more present embodiments, a user may view information collected about him/her. Unlike cookies and other tracking mechanisms, with one or more present embodiments, a user may provide input as to whether and/or how collected information may be used for target advertising.

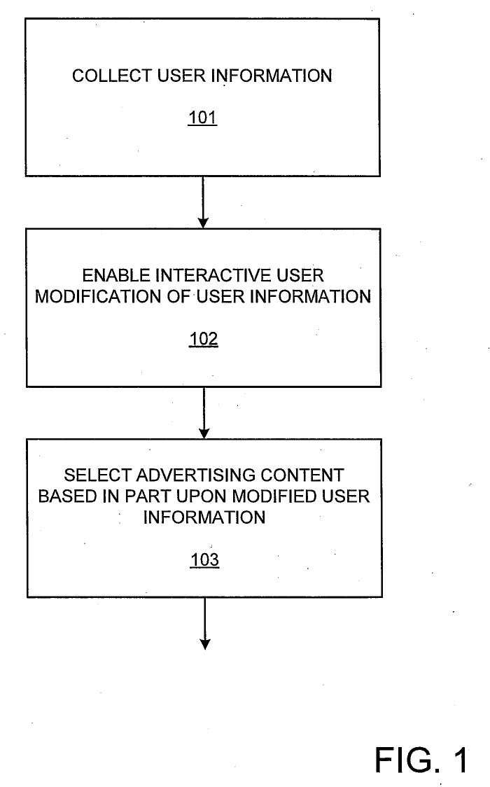

As shown in FIG. 1, in accordance with an embodiment, a method is provided for target advertising. As shown at 101, the method includes collecting information associated with a user. User information may be collected from various sources, such as but not limited to, information associated with a user by one or more user accounts or identifiers and/or one or more of the user's online activities. Collected user information is not limited to online sources, but may be collected from other sources such as in-person meetings, telephone interviews, mailings, print information, reports, government records, by way of example. It should be understood that claimed subject matter is not intended to be limited to one or more particular sources. As depicted at 102, the method includes enabling a user to interactively modify and/or provide feedback to at least a portion of user information. Information may be provided to or displayed for a user to facilitate the user's ability to interactively modify and/or provide feedback regarding such information. As shown at 103, the method includes selecting advertisement content to be directed to a computing platform associated with the user based, at least in part, on the modified user information.

Information collected at 101 may include information declared by a user. Declared information may comprise information that a user submits to a website or webpage. Declared information may comprise information that a user provides via telephone, in person meeting, and/or from various print materials, such as reports, writings, government records and/or other media. Declared information may comprise information regarding or associated with a user obtained from computer, online, document or other sources. Examples may include user account information, information that a user enters into a web based form or database, or user survey information. In particular embodiments, declared information may include user demographic information, such as but not limited to name, address, gender, age, or information about a user's hobbies, family or profession. Declared information may also include user responses to questions or surveys about user interests, such as gardening, transportation, travel, shopping, dining, athletics and/or activities. Of course, these are merely examples of possible declared user information and claimed subject matter is not so limited.

In various embodiments, information collected at 101 may also include observed information associated with a user. For example, in various embodiments, observed information may include click stream information, or information about which websites and/or webpages a user visits. Observed information may include information about one or more durations of time a user is on a particular website and/or webpage. Observed information may include information about one or more search terms a user selects for performing one or more internet searches. Observed information may include information about a user viewing or clicking on one or more advertisements. These are merely examples of possible observed user information and claimed subject matter is not intended to be so limited.

Additionally, information collected at 101 may also include inferred information. Such inferred information may include information inferred about a user based upon declared user information and/or observed user information. Inferred information may be based upon advertising models, for example. In one implementation, inferred information may be based upon an evaluation of one or more patterns in user data and correlating such patterns to one or more interests of a user. For example, a user performing internet searches for toddler beds, may be more interested in minivans than a user looking for vacation resorts for singles. Also, a user visiting websites about fine wine may be interested in fine dining. In yet another example, a user performing internet searches for real estate agents may be interested in mortgage rate information. It should be understood, however, that these are merely examples of how inferred information may be determined according to particular embodiments and that claimed subject matter is not intended to be limited to these particular examples.

In one or more embodiments, as depicted at 102, a user may be able to interactively modify and/or provide feedback regarding at least a portion of user information associated with the user. For example, a user may be able to edit declared information, such as but not limited to, by editing user account information and/or providing updated address information.

In various embodiments, a user may be able to interactively modify and/or provide feedback regarding at least a portion of user information by specifying one or more user preferences. For example, a user may be able to specify one or more preferences about which interest category(ies) should be utilized for interest matching and/or target advertising. For example, a user may be able to select that (s)he prefers to have interest matching with an “automotive” interest category, but not with a “fashion” interest category. In various embodiments, collected information may be displayed or available to a user, so that the user may view what information is associated with him/her and then the user may be given one or more opportunities to indicate one or more preferences for which collected information should be used and/or disregarded for selecting target advertising content for that user. Again, these examples are merely possible embodiments and claimed subject matter is not so limited.

A user may also be able to interactively modify at least a portion of the user information by providing feedback about inferred information. For example, in various embodiments, a user may be able to state whether or not an inference is accurate. For example, if a user performing Internet searches for toddler beds is targeted as being interested in purchasing minivans, the user may have one or more opportunities to provide input as to whether s/he is actually interested in minivans. Again, claimed subject matter is not intended to be limited to these particular examples.

In various embodiments, as shown at 103, advertisement content may be selected to be directed to a computing platform associated with the user based, at least in part, on the modified user information. For example, based upon a user updating declared address information to reflect that the user has moved from California to Michigan, advertising content presented to that user may include Michigan businesses and/or be modified to include Michigan businesses as opposed to California businesses, if advertising content includes one or more local businesses geographically near that user.

In some embodiments, advertising content may be selected to include one or more interest categories for which a user as indicated a preference to use for advertising content selection. For example, if a user indicates a preference for interest matching to include “consumer electronics,” advertising content may be selected to include consumer electronics. Conversely, advertising content may be selected to exclude one or more interest categories for which a user has indicated a preference to exclude from consideration in selecting advertising content. For example, if a user indicates that s/he is not interested in “finance,” advertising content may be selected to exclude finance related advertisements. As a further example, if a user indicates that inference data is not accurate, that data may be excluded from consideration for selecting advertising conterit. Claimed subject matter is not intended to be limited to these examples.

In some embodiments, the user information may be displayed to the user upon successful user authentication procedure, such as but not limited to, user entry of a username and password. In this particular implementation, user information may not be publicly available. In this sense, user information may be only displayed or provided to the user upon successful password authentication. Again, this is merely an example of how user information may be accessed for interaction and claimed subject matter is not limited to this particular detail associated with one or more embodiments.

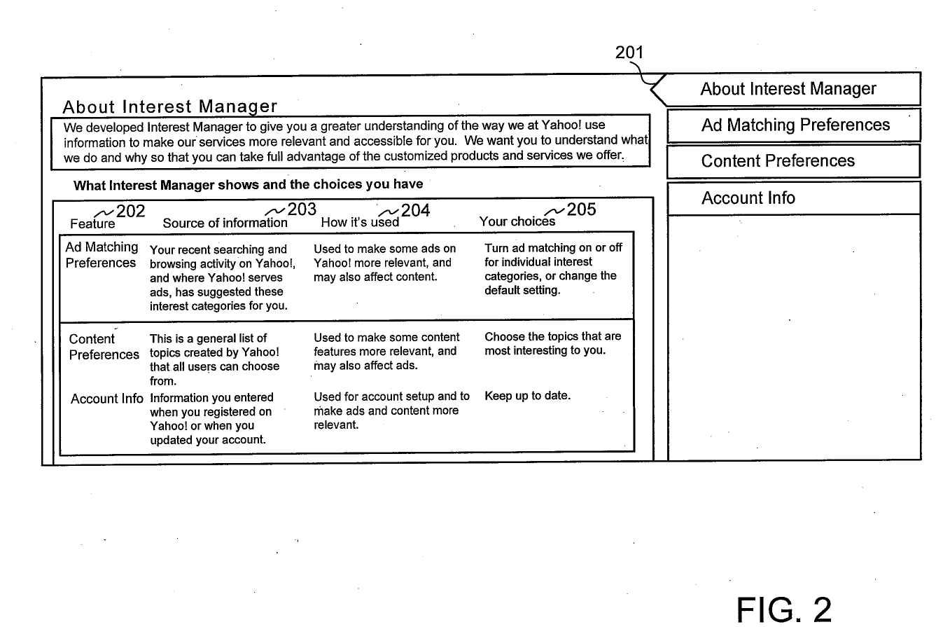

FIGS. 2-5 depict computer screenshots that may appear in a browser that is capable of receiving user selections from a graphical user interface (GUI).

FIG. 2 shows a computer screenshot of an example user interface for an interest manager, in accordance with some embodiments. A user may sign in to his/her user account and be presented with a user interface, such as but not limited to the user interface depicted in FIG. 2. In this embodiment, selecting tab “About Interest Manager” 201 may allow a user to view information about an interest manager embodiment. Feature 202 may list one or more features of interest manager. In this embodiment, feature 202 lists “ad matching preferences,” “content preferences” and “account info” features. “Source of Information” 203 may list sources of information associated with one or more features listed in feature 202. For example, in this particular embodiment, the source for ad matching preferences may be recent searching and browsing activity on Yahoo!. “How it's Used” 203 may identify how the different features are used for selecting advertising content. For example, ad matching preferences in this particular embodiment may be used to affect ad content. “Your choices” 204 may identify how a user may provide input to the features based upon his/her interests. For example, “Your choices” 204 identifies that a user may turn ad matching on or off for individual interest categories in this embodiment. It should be understood that these are merely examples of a particular user interface and claimed subject matter is not intended to be limited to these details of this particular embodiment.

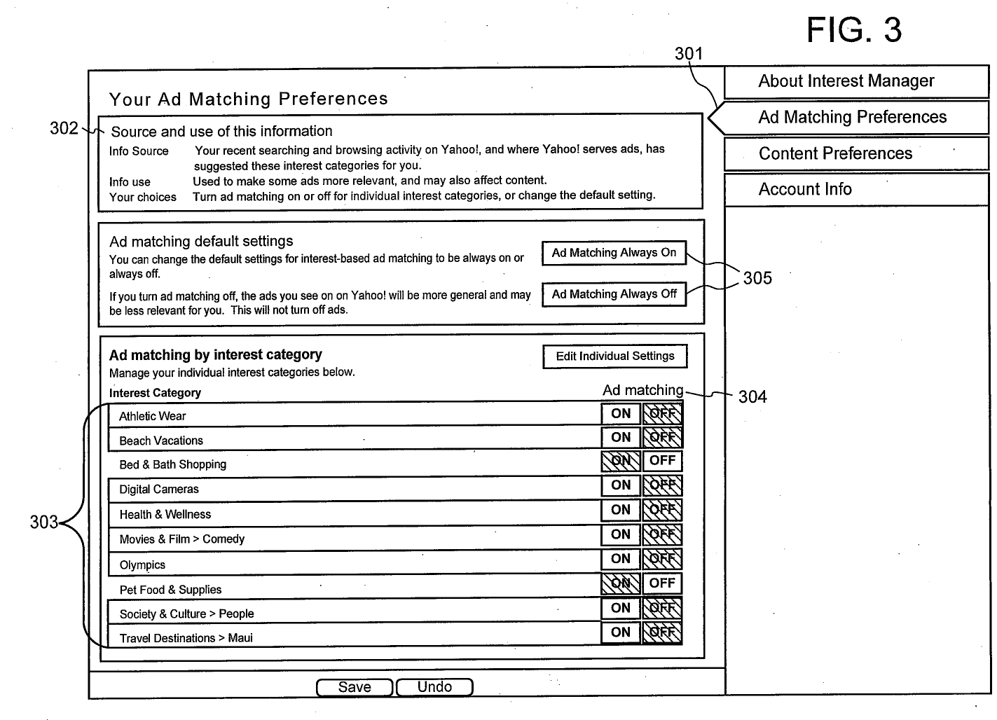

FIG. 3 is a screenshot depicting a user interface showing possible ad matching preferences in accordance with an embodiment. In this particular embodiment, ad matching preferences may be used to make advertising more relevant for a user and/or affect advertising content. Similar to the user interface of FIG. 2, tab “Ad Matching Preferences” 301 may allow a user to view information about ad matching preferences in an interest manager embodiment. Source 302 may indicate one or more sources and/or uses for user account information. One or more interest categories 303 may be provided. For one or more interest categories, a user may be able to turn ad matching 304 on or off. Advertising content may be based at least in part upon interest categories 303 for which a user has turned ad matching on. Advertising content may be based at least in part upon interest categories 303 for which a user has turned ad matching off, in that categorie(s) turned off may be excluded from advertising content in some embodiments. In this particular embodiment, a user may also edit ad matching default settings 305 by globally turning ad matching on or off for all categories. It is to be understood that these are merely examples of one type of an ad matching feature that may be present with one or more embodiments and claimed subject matter is not intended to be limited to this particular embodiment.

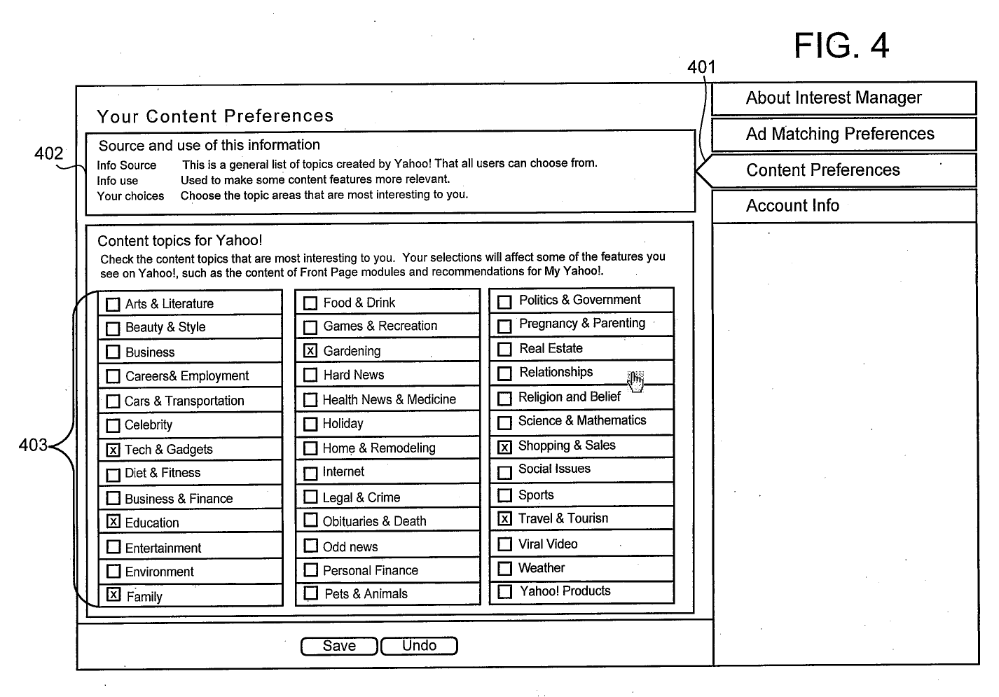

FIG. 4 is a screenshot depicting a user interface showing possible content preferences in accordance with an embodiment. Similar to the screenshot of FIG. 2, tab 401 may allow a user to view information about content preferences in an interest manager embodiment. Content preferences may be used to make advertising more relevant for a user and/or affect advertising content. Source 402 may indicate one or more sources or uses for content preferences. In this embodiment, source 402 indicates that content consists of a general list of topics for all users. Content topics 403 may be selected or deselected by a user to indicate one or more preferences for topics to be included or excluded from advertising content. For example, this embodiment shows content topic 403 “Family” selected for inclusion in content, but content topic 403 “Business” is not selected for inclusion. Again, these are merely examples of one type of user interface having one type of content preferences that may be available with one or more embodiments, and claimed subject matter is not intended to be limited to this particular embodiment.

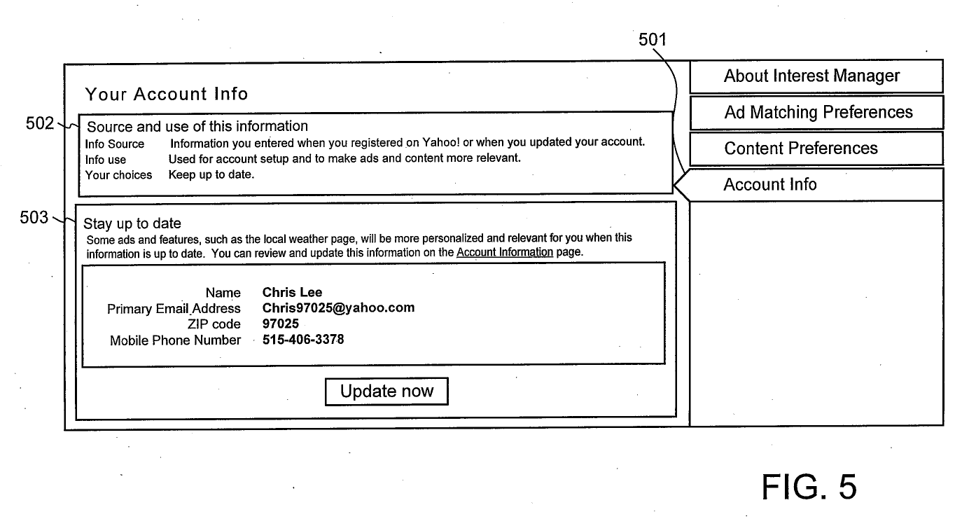

FIG. 5 is a screenshot depicting a user interface showing possible user account information in accordance with an embodiment. Similar to the screenshot of FIG. 2, tab 501 may allow a user to view user account information in an interest manager embodiment. Source 502 may indicate one or more sources and/or uses for user account information. “Stay up to Date” 503 displays some user account information and allows for a user to update such user account information. Again, this is merely one possible example of a user interface having one type of possible account information and claimed subject matter is not intended to be limited to this particular embodiment.

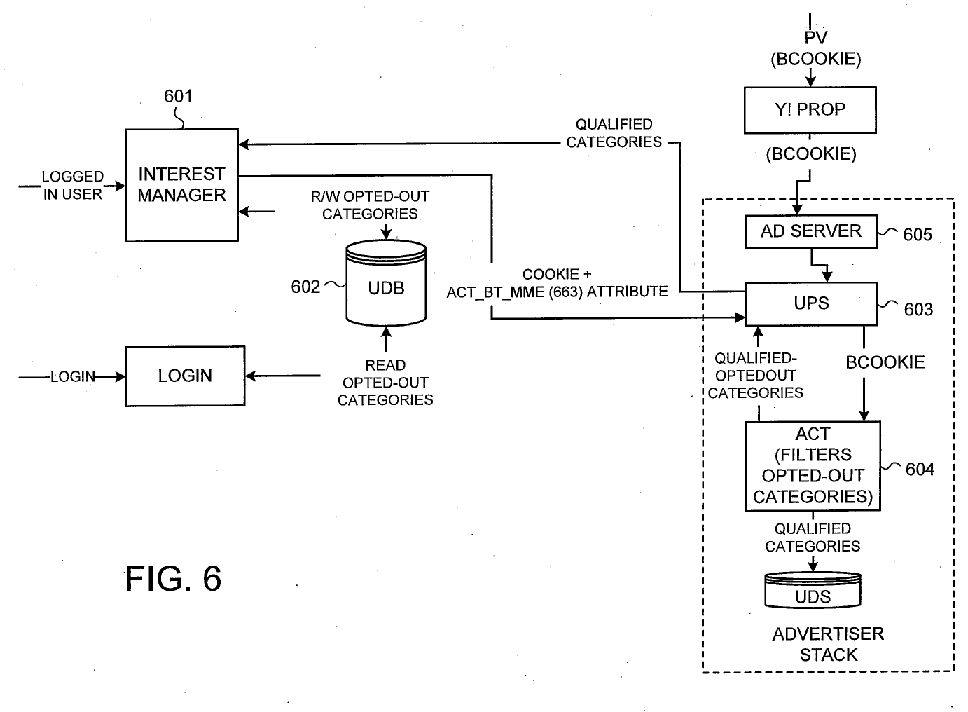

FIG. 6 is a diagram showing an embodiment of an architecture of an interest manager. Interest Manger 601 may read and write data, such as but not limited to collected user information and/or modified user information and/or feedback regarding user information to UDB 602 and UPS 603. UDB 602 is a “user data base” and for the purpose of Interest Manager 601, may store user opt out categories for Ad Matching Preferences. Interest manager 601 may read data, such as but not limited to user information, modified user information and/or feedback regarding user information received from UPS 603. UPS 603 may give Interest Manager 601 a list of a user's qualified categories and may store a user's Content Preferences. Interest manager 601 may post a list of one or more opted out categories. Data platform ACT 604 may receive a bcookie containing Interest Manager 601 Ad Matching Preferences opt outs, and filter out any qualified interest categories that may have been passed to it. Qualified interest categories filtered by data platform ACT 604 may be respected by the MME-Ad Server 605. MME-Ad Server 605 may upload user identification information and/or interest category 303 information to UPS 603.

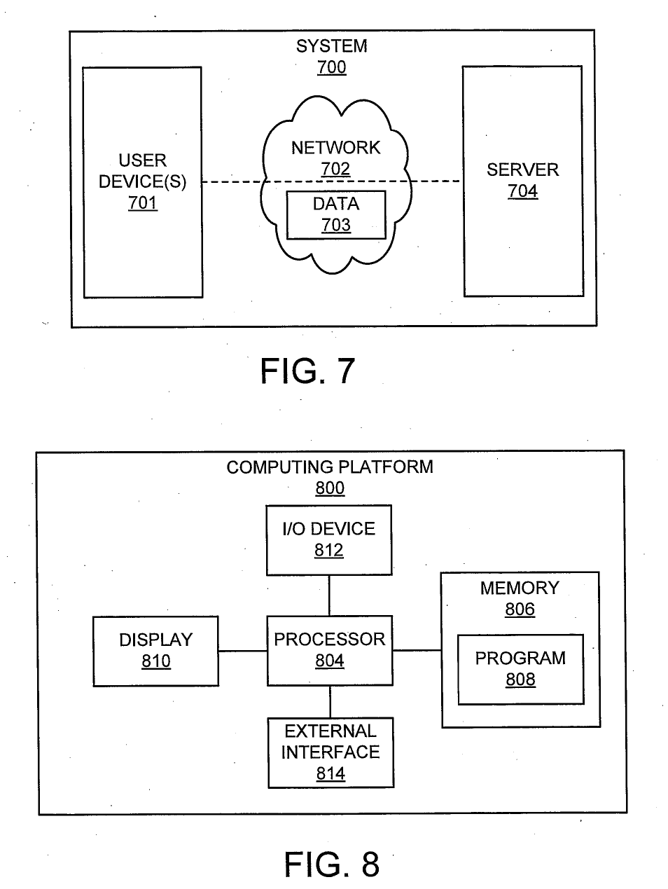

FIG. 7 shows a system for providing targeted advertising according to an embodiment. System 700 includes one or more user devices 701, which may be used to input data 703, such as user information and/or modifications to user information. User device 701 may be a computing device, handheld device, PDA, cellular device or any other device known in the art that is capable of inputting data 703. User device 701 may be used to upload data 703, such as user information and/or modifications to user information, to a server 704 via network 702. In some embodiments, server 704 may be capable of storing and/or analyzing user information and/or modifications to or feedback regarding user information. In some embodiments, server 704 may be capable of selecting or generating one or more advertising contents and/or providing for display one or more advertising contents, and/or communicating with a separate database or server within one or more networks that selects and/or generates one or more advertising contents and/or provides for display one or more advertising contents. Claimed subject matter is not intended to be limited to this particular embodiment.

Referring to FIG. 8, a block diagram of a computing platform 800 according to one or more embodiments is illustrated, although the scope of claimed subject matter is not limited in this respect. Computing platform 800 may include more and/or fewer components than those shown in FIG. 8. However, generally conventional components may not be shown, for example, a battery, a bus, and so on.

Computing platform 800, as shown in FIG. 8 may be utilized to embody tangibly a computer program and/or graphical user interface by providing hardware components on which the computer program and/or graphical user interface may be executed. Computing platform 800 may be utilized to embody tangibly all or a portion of FIGS. 1-6 and/or other procedures disclosed herein. Such a procedure, computer program and/or machine readable instructions may be stored tangibly on a computer and/or machine readable storage medium such as a compact disk (CD), digital versatile disk (DVD), flash memory device, hard disk drive (HDD), and so on. As shown in FIG. 8, computing platform 800 may be controlled by processor 804, including one or more auxiliary processors (not shown). Processor 804 may comprise a central processing unit such as a microprocessor or microcontroller for executing programs, performing data manipulations, and controlling the tasks of computing platform 800. Auxiliary processors may manage input/output, perform floating point mathematical operations, manage digital signals, perform fast execution of signal processing algorithms, operate as a back-end processor and/or a slave-type processor subordinate to processor 804, operate as an additional microprocessor and/or controller for dual and/or multiple processor systems, and/or operate as a coprocessor and/or additional processor. Such auxiliary processors may be discrete processors and/or may be arranged in the same package as processor 804, for example, in a multicore and/or multithreaded processor; however, the scope of the scope of claimed subject matter is not limited in these respects.

Communication with processor 804 may be implemented via a bus (not shown) for transferring information among the components of computing platform 800. A bus may include a data channel for facilitating information transfer between storage and other peripheral components of computing platform 800. A bus further may provide a set of signals utilized for communication with processor 804, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the. Institute of Electrical and Electronics Engineers (IEEE) including IEEE 488 general-purpose interface bus (GPIB), IEEE 696/S-100, and so on, although the scope of the scope of claimed subject matter is not limited in this respect.

Other components of computing platform 800 may include, for example, memory 806, including one or more auxiliary memories (not shown). Memory 806 may provide storage of instructions and data for one or more programs 808 to be executed by processor 804, such as all or a portion of FIGS. 1-6 and/or other procedures disclosed herein, for example. Memory 806 may comprise, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 806 may comprise, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 806 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 800 further may include a display 810. Display 810 may comprise a video display adapter having components, including, for example, video memory, a buffer, and/or a graphics engine. Such video memory may comprise, for example, video random access memory (VRAM), synchronous graphics random access memory (SGRAM), windows random access memory (WRAM), and/or the like. Display 710 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth.

Computing platform 800 further may include one or more I/O devices 812. I/O device 812 may comprise one or more I/O devices 812 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like.

Computing platform 800 further may include an external interface 814. External interface 814 may comprise one or more controllers and/or adapters to prove interface functions between multiple I/O devices 812. For example, external interface 814 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 812.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that if executed by a system, such as a computer system, computing platform, or other system, for example, may result in the system performing techniques for groundwater monitoring in accordance with claimed subject matter. Such techniques may comprise one or more of the example embodiments described herein, for example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
collecting user information associated with a user;
enabling said user to interactively modify at least a portion of said user information; and
selecting advertisement content to be directed to a computing platform associated with said user based, at least in part, on said modified user information.

2. The method of claim 1, wherein said collected user information comprises information declared by said user.

3. The method of claim 1, wherein said collected user information comprises observed information regarding said user.

4. The method of claim 3, wherein said observed information comprises at least one of click stream information, website visitation information, website length of stay information, or internet search information.

5. The method of claim 3, further comprising enabling said user to interactively modify said collected user information by specifying one or more user preferences.

6. The method of claim 1, wherein said collected user information comprises inferred information.

7. The method of claim 6, wherein said inferred information is based at least in part upon observed information and/or information declared by said user.

8. The method of claim 6, further comprising enabling said user to interactively modify said collected user information by specifying accuracy of at least part of said inferred information.

9. The method of claim 6, further comprising:
providing one or more ad matching preferences that are based at least in part upon said inferred information, and enabling said user to turn off at least one of said ad matching preferences, wherein said advertising content is based at least in part upon said ad matching preferences.

10. The method of claim 1 wherein said collected user information comprises one or more interest categories.

11. The method of claim 1 further comprising displaying one or more sources for said collected user information.

12. An apparatus, comprising:
an interest manager capable of accepting user feedback regarding collected user interest information and capable of generating advertising content based at least in part upon said collected user interest information and said user feedback.

13. The apparatus of claim 12 wherein said collected user interest information is capable of being interactively changed by one or more user edits.

14. The apparatus of claim 12 wherein said collected user interest information comprises at least one of information declared by said user, observed information regarding said user or inferred information.

15. The apparatus of claim 12 wherein said interest manager is capable of providing content preferences comprising one or more content topics that are capable of being selected by a user, wherein said advertising content is based at least in part upon said selected content topics.

16. The apparatus of claim 12 wherein said interest manager is capable of providing one or more ad matching preferences that are based at least in part upon said collected user interest information and which are capable of being turned off by a user, wherein said advertising content is based at least in part upon said ad matching preferences.

17. An article, comprising: a storage medium having stored thereon instructions that, if executed by a computing platform, are adapted to direct said computing platform to:
change collected user information at least partially in response to user feedback; and
generate advertising content based at least in part upon said changed collected user information.

18. The article of claim 17 further comprising: a storage medium having stored thereon instructions that, if executed by a computing platform, are adapted to direct said computing platform to:
display said collected user information and/or said advertising content.

19. The article of claim 17 further comprising: a storage medium having stored thereon instructions that, if executed by a computing platform, are adapted to direct said computing platform to:
generate one or more ad matching preferences based at least in part upon said collected user information; and
generate said advertising content based at least in part upon user feedback regarding said ad matching preferences.

20. The article of claim 17 further comprising: a storage medium having stored thereon instructions that, if executed by a computing platform, are adapted to direct said computing platform to:
generate one or more content preferences based at least in part upon said collected user information; and
generate said advertising content based at least in part upon user feedback regarding said content preferences.
